(19) United States
(12) Patent Application Publication
(10) Pub. No.: US 2011/0071962 A1
(43) Pub. Date: Mar. 24, 2011

(54) Method and system of using network graph properties to predict vertex behavior

(76) Inventor: Nicholas Lim, Arlington, MA (US)

(21) Appl. No.: 12/884,419

(22) Filed: Sep. 17, 2010

Related U.S. Application Data
(60) Provisional application No. 61/243,722, filed on Sep. 18, 2009.

(51) Int. Cl. G06F 15/18; G06N 5/02

(52) U.S. Cl. 706/10; 706/12; 706/46

(57) ABSTRACT

Network graphs are determined using data about the vertices. Vertices are clustered into community of vertices based on maximizing the density of linkages within each community. Vertex properties describing the extent to which each vertex's community has exhibited a particular behavior are determined. Vertex properties describing whether the most important vertex in each community has exhibited a particular behavior are determined. Functions describing the relationship between these two categories of vertex properties and other relevant vertex properties, and a particular behavior are determined. These functions are used to predict the likelihood of each vertex exhibiting the particular behavior.

### CROSS REFERENCE TO RELATED APPLICATIONS

This application claims the benefit of PPA Ser. No. 61/243,722 filed Sep. 18, 2009 by the present inventor.

### BACKGROUND OF THE INVENTION

The present invention is in the field of systems and methods for business analytics, and particularly to systems and methods for scalable and fault-redundant predictions utilizing networked or graph data. It has now become common for businesses to analyze and predict the behaviors of customers. Accurate predictions of customer behaviors allow businesses to tailor their offerings and interactions with them. Traditional methods of predictions use historical behaviors of and personal information about the customers. Examples of such information include the age, gender, income, purchase volume in the past month. Such information is usually provided to a data mining system which creates a mathematical function to describe how these information can be combined to predict a customer's behavior. The effectiveness of such analysis is determined by how accurate the predictions are. Current techniques provide promising but not perfect predictions.

One object of the invention is improvement of the accuracy of such predictions. One reason that current techniques are less than perfect is that they do not capture the social and connected nature of customer behavior. Customers' perceptions and behaviors are affected by word-of-mouth and their social community. Such influences have not been captured in traditional prediction techniques and tools. Capturing the influence of social connections and integrating them into the traditional prediction techniques improves prediction accuracy. Identifying the influence of social connections can be accomplished using mathematical graph theory. The term “graphs” refer to networks rather than visual charts.

One object of the invention is enabling the completion of analysis of extremely large network graphs within practically useful timeframes. An analysis that takes one month to complete is less useful than one completed in a few hours. As an example, if a network analysis is undertaken to predict the likelihood that a visitor to a social network website will cease his/her visits, completing the analysis in one month is not useful as the visitors might have already ceased to visit the website. On the contrary, if the network analysis completes within a few hours, the social network website has the potential to offer incentives to their visitors to return to the website.

The scalability challenge derives from the existing approach of analyzing the network graphs using one analytical task for one computational agent. The invention solves this issue by sub-dividing both the computation task and the storage of network graphs into smaller tasks and smaller net-work graphs respectively, and executing and storing them respectively on independent computational agents, for example different computer servers.

### BRIEF SUMMARY OF THE INVENTION

In some implementations, a network graph can be used to represent the connected relationships between different objects, such as customers or visitors to a social network website.

In some implementations, in predicting whether each vertex will exhibit a specific behavior, including information on the extent to which the community of each vertex has already exhibited said behavior, or a related behavior, improves accuracy of the prediction.

In some implementations, in predicting whether each vertex will exhibit a specific behavior, including information on whether the most connected and important vertex, in the community of each vertex, has already exhibited that behavior, or a related behavior, improves accuracy of the prediction.

In some implementations, a system includes a distributed set of agents, consisting of graph information storage engine, graph calculation engine, graph controller and graph modeling engine. The graph controller may divide graphs into smaller graphs, called subgraphs, may divide one calculation task into smaller tasks. The graph information storage engine may store the subgraphs in different computational servers. The graph calculation engine may calculate the community and leader-influenced based vertex properties. The graph modeling engine may determine the mathematical relationship between the graph vertex properties and a desired behavior.

This summary is provided to introduce a selection of concepts in a simplified form that are further described in the detailed description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an exemplary usage of prediction task in a business setting

FIG. 2 illustrates an exemplary workflow of a prediction task using network graph properties

FIG. 3 illustrates an exemplary workflow of generating network graph properties pertaining to community pressure exerted on each vertex, and the influence of important vertices.

FIG. 4 illustrates an exemplary system.

### DETAILED DESCRIPTION

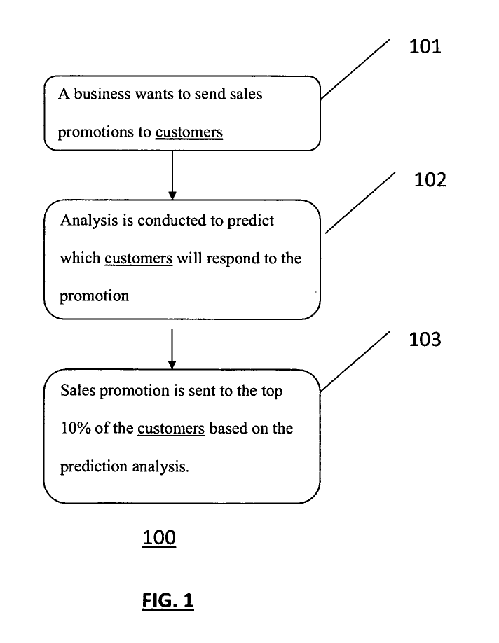

FIG. 1 illustrates an exemplary usage of predictive task in a business setting. At stage 101, a business entity may decide that it wants to send a sales promotion to its customers for a particular product. In order to improve the effectiveness of such a promotion, the business entity decides to identify the best customers for such a promotion. To identify these best customers, analysis, in stage 102, is executed to predict which customers are most likely to respond to this promotion. The output of stage 102 is a top 10% list of customers who are predicted to respond to the sales promotion. In stage 103, the business sends the sales promotion to the list generated by stage 102.

In stages 101, 102 and 103, the common object being discussed is “customers”. This common object is referred to as the “object of analysis”. In an implementation and usage, this object of analysis may refer to other entities including, but not limited to, credit card applications, website visitors and users.

In stages 101, 102 and 103, the common goal being discussed is to find customers most likely to respond to a promotion. This common goal is referred to as a “target variable”. In an implementation and usage, this common target variable may refer to other goals including, but not limited to, being fraudulent or defecting to a competitor.

In an implementation and usage, the predictive task accomplished in Stage 102 may combine different objects and target variables. Examples include, but are not be limited, to the following:
Identifying customers most likely to defect to a competitor
Identifying customers most likely to stop subscribing to a service
Identifying credit card applications most likely to be fraudulent
Identifying users most likely to respond to an online advertisement
Identifying customers most likely to spread positive feedback about a product.
Identifying website visitors most likely to click on an advertisement from a product catalog

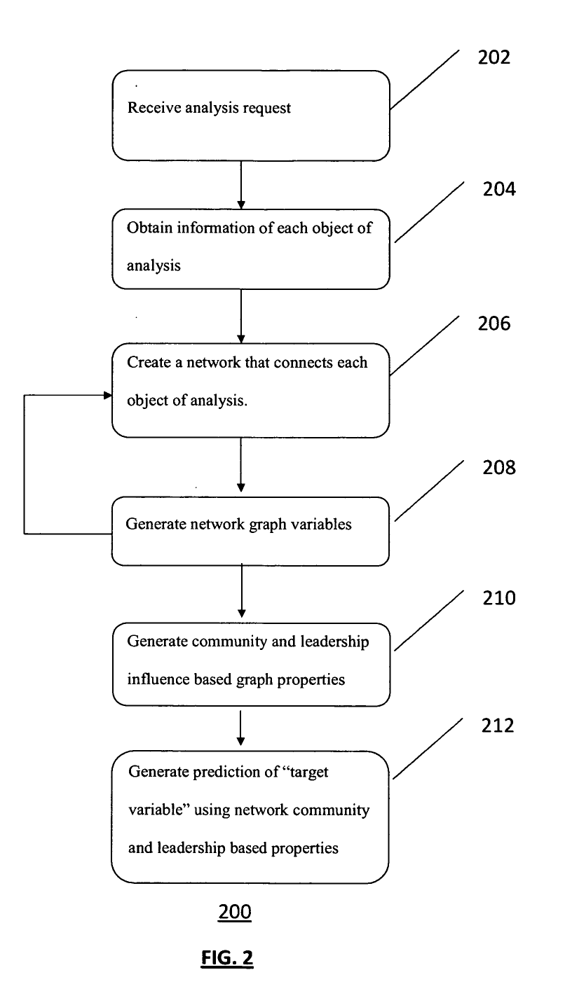

FIG. 2 illustrates an exemplary process of analysis and prediction, which an implementation would perform in stage 102. In stage 202, a request for analysis is received. This request includes the specification of the object of analysis, for example customers or credit applications, and the target variable, for example responding to a promotion or being fraudulent respectively.

In stage 204, information about each object of analysis is obtained. In an implementation, information may be stored in multiple data storage systems and in different formats. For example, customers may have their personal information stored in one database, but their sales histories stored in a separate system.

In stage 206, the information about each object of analysis, for example a customer, is converted into a network graph. A network graph is a data structure that describes vertices that are connected via edges and arcs. In an implementation, a customer graph might consist of customer vertices, in which an edge connecting two customers is created when a telephone call or message was exchanged between two customers. In an implementation, a customer graph might consist of visitors to a social networking website, in which an edge connecting two visitors is created when a message was exchanged between two visitors on the social networking website.

In mathematical terms, a graph comprising of a set of vertices V and a set of edges E is represented as G(V,E). This graph representation of customers provides a way to capture and quantify the social influence of connections between objects of analysis, for example customers.

In stage 208, properties of the vertices and edges are further calculated. Categories of properties include weights of the edges and the connectivity of the vertices. A higher weight for an edge signifies stronger relationship between the two vertices. Higher connectivity of each vertex signifies a measure of importance and reach. In an implementation, the number of calls made per customer may be calculated and used as a connectivity measure. In an implementation, the number of calls between two customers may be used as a weight of the edge between the two associated vertices.

In an implementation, the number of messages sent by a website visitor may be calculated and used as a connectivity measure. In an implementation, the number of social networking website messages exchanged between two website visitors may be used as a weight of the edge between the two associated vertices.

After stage 208, the network graph of the object of analysis may be altered by removing vertices and/or edges whose properties calculated in stage 208 do not meet specific criteria. In an implementation, where graph G(V,E) contains V, the set of customers of a telecommunications company, and E the set of calls made between customers of the same telecommunications firm, vertices whose connectivity exceeds a certain threshold may be removed from the graph. For example, customers with more than 100000 calls per month may be removed. In an implementation, where graph G(V,E) contains V, the set of customers of a telecommunications company, and E the set of calls made between customers of the same telecommunications firm, edges where the weights is below a certain threshold may be removed from the graph. For example, edges where the total number of calls between the associated vertices is below 20 may be removed from the graph.

In an implementation, where graph G(V,E) contains V, the set of visitors to a social networking website, and E the set of messages made between these visitors on the social networking website, vertices whose connectivity exceeds a certain threshold may be removed from the graph. For example, visitors with more than 100000 sent messages per day may be removed, as these visitors are likely to be a spam bots. In an implementation, where graph G(V,E) contains V, the set of visitors to a social networking website, and E the set of messages made between these visitors on the social networking website, edges whose weights is below a certain threshold may be removed from the graph. For example, edges where the total number of messages between the associated vertices is fewer than 5 per month may be removed from the graph, as these edges constitute rare and infrequent messages and therefore are indicative of low relationship strength. An iterative loop between stage 3 between stage 206 and 208 is undertaken until all vertices and edges in the graph G meet the required criteria. At the end of this loop, the process proceeds to stage 210.

In stage 210, the network graph is analyzed and two categories of vertex properties are generated. Within a network graph, it is possible to identify communities of vertices that belong together. The first category of vertex properties characterize the community of each vertex with respect to a specific behavior, for example a telecommunications customer defecting to a competing telecommunications provider, or a social network website visitor deleting his/her account on the social network website.

Within a network graph, it is possible to identify important vertices by calculating various centrality measures such as eigenvector centrality and degree centrality. The second category of vertex properties generated in stage 210 characterize the influence of an important vertex on the vertices that reside in the same community as the important vertex.

In stage 212, the output from stage 210 are included into a predictive analytics system. The predictive analytics system will create the best fitting mathematical function that describes the relationship between the output from stage 210 and the target variable behavior. This mathematical function is then used to predict how likely any object of analysis will exhibit the target variable behavior, by substituting the particular values of the object of analysis into the mathematical function. This output of this function can then be used to rank the object of analysis based on its likelihood to exhibit the target variable behavior. In one implementation, logistic regressions, decision trees, neural networks or support vector machines techniques may be used to determine the best fitting mathematical function.

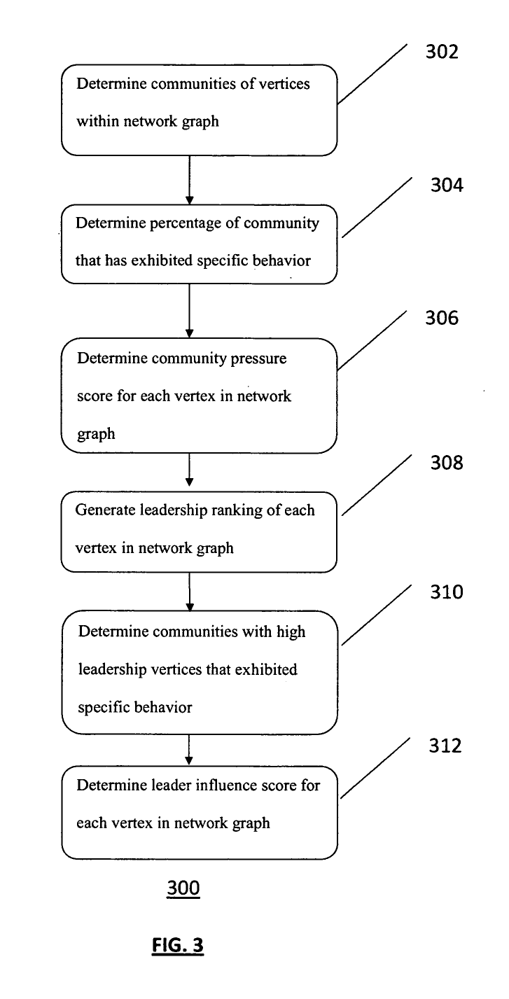

FIG. 3 illustrates an exemplary process of generating community- and leadership influence based properties of vertices, which an implementation would perform in stage 210. In stage 302, vertices of a network graph are clustered into communities. A community is a group of vertices. Modularity is a benefit function used in the analysis of networks or graphs. It quantifies the quality of a division of a network graph into communities. Good divisions, which have high values of the modularity, are those in which there are dense internal edges between the vertices within modules but only sparse connections between different communities. In an implementation, this stage may utilize a modularity maximization algorithm to identify these communities. It should be understood that a community derived from modularity maximization is different from a community derived by grouping one vertex and all its neighboring vertices together, wherein neighboring vertices are defined as the vertices that share an edge with the vertex. In an implementation, the output of stage 302 may be a vector R containing two entries per row: a vertex, and the corresponding identifier of the community, referred here as community ID, that the vertex is a member of.

In stage 304, the output of stage 302—vector R, is compared to a reference list L of vertices. This reference list L contains the vertices that have exhibited a certain behavior or possess certain properties. In an implementation, where graph G(V,E) contains V, the set of customers of a telecommunications company, and E the set of calls made between customers of the same telecommunications firm, list L may contain customers that have canceled their telecommunications service. L may also contain customers who have made a phone call in the past month. In an implementation, where graph G(V,E) contains V, the set of visitors to a social networking website, and E the set of messages made between these visitors on the social networking website, L may contain visitors that have purchased a product from the social networking virtual product catalog.

In comparing vector R with list L, stage 304 calculates the number of vertices in each community that is also found in list L. For each community, stage 304 thus calculates the percentage of each community that is found in list L using the following equation:

$$Percentage of community C 1 in list L = \frac{number of vertices in community C 1 also found in L}{number of vertices in community C 1}$$

The output of stage 304 is a percentage community score for each community. This score is called “community pressure score”.

It is to be understood that the criteria to be included into list L is flexible. In an implementation, where graph G(V,E) contains V, the set of customers of a telecommunications company, E the set of calls made between customers of the same telecommunications firm, and list L contains customers that have canceled their telecommunications service, the community pressure score is the percentage of community vertices that have cancelled their telecommunications service.

In an implementation, where graph G(V,E) contains V, the set of visitors to a social networking website, E the set of messages made between these visitors on the social networking website, and L contains visitors that have purchased a product from the social networking virtual product catalog, the community pressure score is the percentage of the community that has purchased a product from the social networking virtual product catalog.

In stage 306, the community pressure score for each community is applied to all vertices within each community. Each vertex is labeled with the same community pressure score as the community that the vertex is a member of. The intuition and application of such a score is that vertices in a community with high community pressure score are more likely to exhibit the same behavior as the vertices in list L. The output of stage 306 is a vector containing the vertex and its corresponding community pressure score.

It is understood that in an implementation, multiple different community pressure scores representing different list Ls may be generated during stage 306. Correspondingly, there will be multiple output vectors from stage 306.

In stage 308, the importance and leadership property of each vertex in the network graph is calculated. In an implementation, eigenvector centrality and degree centrality may be used to determine importance. Eigenvector centrality assigns relative scores to all vertices in the network based on the principle that connections to high-scoring vertices contribute more to the score of the vertex in question than equal connections to low-scoring vertices. Let Xi denote the score of the ith vertex. Let Ai,j be the adjacency matrix of the network. Hence Ai,j=1 if the ith vertex is adjacent to the jth vertex, and Ai,j=0 otherwise. More generally, the entries in A can be real numbers representing connection strengths, as in a stochastic matrix. Eigenvector centrality is calculated by taking the eigenvector corresponding to the largest eigenvalue in the formula:

Ax=λx

Degree centrality is calculated by counting the total number of edges that is incident onto the vertex. In one implementation, the output is a list of vertices, ranked by its eigenvector centrality score or degree centrality.

In stage 310, the list of vertices output from stage 308 is first processed to identify and retain the most important vertices, while discarding the other vertices. In one implementation, the top 10% of vertices may be retained in list of important vectors. This trimmed list of vertices is then compared with list L. Vertices found in both lists are then stored in new list I. By comparing list I with vector R, a list of communities that have high importance vertices exhibiting a specific behavior, for example the target variable, may be obtained. The output of stage 310, is this list of communities obtained, list C.

In stage 312, the list of communities C obtained from stage 310 is compared with the vector R, the output of stage 302. Vertices in vector R, that have matching community ID in list C, are now given a leader influence score. Vertices in vector R without a matching community ID in list C are given a zero score. In one implementation, these vertices may be given a leader influence score of 1, while other vertices are given a score of 0.

In an implementation, where graph G(V,E) contains V, the set of customers of a telecommunications company, E the set of calls made between customers of the same telecommunications firm, and list L contains customers that have canceled their telecommunications service, the leader influence score identifies customers whose community leaders have canceled their telecommunications service.

In an implementation, where graph G(V,E) contains V, the set of visitors to a social networking website, E the set of messages made between these visitors on the social networking website, and L contains visitors that have purchased a product from the social networking virtual product catalog, the leader influence score identifies visitors whose community leaders have purchased a product from the social networking virtual product catalog.

The intuition and application of such a leader influence score is that vertices whose community leaders have exhibited a certain behavior, are more likely to exhibit the same behavior because of direct influence from the community leader vertex.

These community-based and community-leader-based properties of each vector provide a quantitative measure of social influence on the vertex behaviors. Linking the vertex behavior exhibited, for example the target variable, by list L to other vertices quantifies the potential impact connections have on these spread of target variable behavior in the network graph. The use of these network graph properties of each vertex, in predicting vertex behavior, results in significant improvement in prediction accuracy.

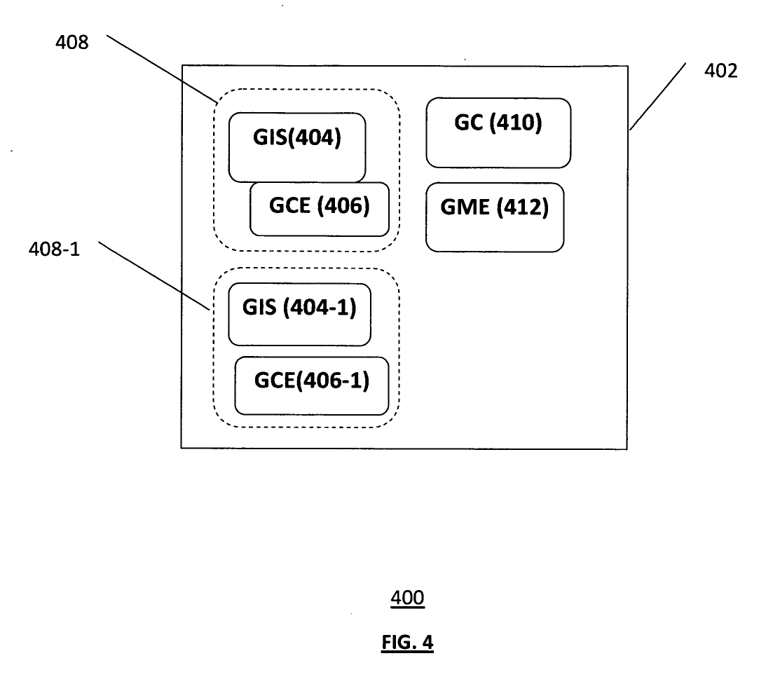

FIG. 4 illustrates an exemplary system used to implement the present innovation. The system 402 may be implemented within computational hardware and software providing the means of input and output, data storage, logic processing and communications among different computational units. The system contains computational agents which have specialized functions. The Graph Information Storage (GIS) 404 is a computational agent which keeps track of and stores data representing the network graph and associated lists and outputs such as L and R. The GIS 404 responds to requests to store or provide network graph and associated data. In an implementation, the data may be stored in different formats, including but not limited to relational databases, index data structures and flat files. The Graph Computation Engine (GCE) 406 is a computational agent which performs network calculations such as identifying communities of vertices, as in Stage 302, and calculating eigenvector centrality, as in Stage 308. In one implementation, the GCE 406 performs all the stages in the exemplary process 300.

In the system, one GIS 404 and one GCE 406 are paired up into a discrete unit 408. Multiple units of 408 may be created and distributed across multiple computational systems, as shown by 404-1, 406-1, 408-1. The GIS 404-GCE 406 pair in 408 allows the system to expand its computation capacity by adding more units of 408. This provides unlimited horizontal scalability, a distinct advantage of such a system as architected and designed.

The Graph Modeling Engine (GME) 412 is a computational agent that analyzes how well the network graph properties predict the target variable. The GME 412 is the computational agent that executes exemplary stage 212. The GME 412 determines a mathematical function, called the predictive function, that best describes the relationship between the target variable and the network graph properties of each vertex.

The activities of each computation unit are coordinated by the Graph Controller (GC) 410. The GC 410, in one implementation, divides a large network graph into smaller subgraphs to be stored on individual GIS 404. The GC 410, in one implementation, divides one graph computation task into smaller tasks, which are distributed to the GCE 406. The GC 410 collects the results of the distributed graph calculations from the disparate GCE 406, and computes the final calculation. The GC 410, in one implementation, also distributes tasks to the GME 412.

In one implementation, a GCE 406 that is paired with a GIS 404, may require network graph and other data not stored on the paired GIS 404. The GCE 406 communicates with the GC 410 to determine the location of the required data and retrieves said data from the other GIS 404-1.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e. instructions) embodied in tangible media, such as CD-ROMS, hard-drives, or any other machine-readable storage medium. Where the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment. Still further, aspects of the presently disclosed subject matter may be implemented in or across a plurality of processing chips or devices, and storage may similarly be affected across a plurality of devices. Such devices might include PCs, network servers, and handheld devices, for example.

It will be appreciated and should be understood that the exemplary implementations of the invention described can be implemented in a number of different fashions. Given the teachings of the invention provided herein, one of ordinary skill in the related art will be able to contemplate other implementations of the invention. Indeed, although exemplary implementations of the present invention have been described herein with reference to the accompanying drawings, it is to be understood that the invention is not limited to those precise implementations, and that various other changes and modifications may be made by one skilled in the art without departing from the scope or spirit, of the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, comprising:
Determining a network graph using data.
Determining the weights of the relationship between the vertices in the network graph
Determining the relevance score of each vertex in the network graph
Altering the network graph based on the weights on relationship and the relevance score of the vertices
Determining network graph properties for each vertex
Determining a mathematical function, called a predictive function, that best describes the relationship between the network graph properties for each vertex, and/or other data elements not derived from the network graph, and a target variable behavior.
Determining whether a vertex will exhibit the target behavior using the mathematical function derived in the aforementioned predictive function.

2. The method of claim 1, further comprising:
Clustering the network graph into communities of vertices based on density of edges within each community
Determining a community pressure score for each vertex based on the percentage of its community that has exhibited specific behavior, for example the target variable.
Determining a mathematical function, called the predictive function, that best describes the relationship between these community scores and a target variable behavior.
Determining whether a vertex will exhibit the target behavior using the mathematical function derived in the aforementioned predictive function.

3. The method of claim 1, further comprising:
Determining the leadership ranking of vertices by calculating various centrality measures such as eigenvector centrality and degree centrality.
Determining the communities that vertices with high ranking leadership scores and who have exhibited specific behavior, for example the target variable, belong to.
Determining a leader-influence score for vertices contained within these said communities.
Determining a mathematical function, called the predictive function, that best describes the relationship between these leader-influence scores and a target variable behavior.
Determining whether a vertex will exhibit the target behavior using the mathematical function derived in the aforementioned predictive function.

4. A method comprising:
Dividing one large network graph into smaller graphs, called subgraphs.
Storing multiple copies of said subgraphs on multiple physical computation machines.
Dividing a calculation task for an entire network graph into smaller tasks, called subtasks, that work on the subgraphs.
Distributing graph calculation subtasks to the physical computation machines that store the respective subgraphs.
Combining the results from subtasks into the final result

5. A computing system, comprising:
A network graph information storage engine (GIS) whose working units are distributed across one or more computational servers
A network graph calculation engine (GCE) whose working units are distributed across one or more computational servers
A network graph modeling engine (GME) whose working units are distributed across one or more computational servers
A master graph controller (GC) that controls the tasks of GIS, GCE, GME and GAE.

6. The system of claim 5, wherein data representing one single network graph is subdivided by the GC into subgraphs, which are distributed to the respective GIS for storage, in the manner that multiple copies of each subgraph are stored by the entire system.

7. The system of claim 6, wherein, in response to the failure of any GIS working unit on any computational server, the system is made aware of such failure leading to surviving GIS units replicating the subgraphs that stored on the failed GIS working unit.

8. The system of claim 7, wherein one GCE unit is paired with one GIS unit, and wherein calculation tasks are subdivided by GC and distributed to respective GCE units for completion, wherein each GCE unit performs its calculation task on the subgraph data located within the corresponding GIS unit on the same computational server.

9. The system of claim 8, wherein network graph and associated data that is required by one GCE unit that is not found in its corresponding paired GIS, is retrieved from the other GIS units.

10. The system of claim 9, wherein the community that each vertex is a member of is determined by examining the density of the connections within each proposed community.

11. The system of claim 10, wherein a property of each vertex is determined, which represents the percentage of each vertex's community that has exhibited a specified behavior.

12. The system of claim 11, wherein the importance of each vertex is ranked and determined using eigenvector centrality, degree centrality and/or similar measures of connectivity.

13. The system of claim 12, wherein a property of each vertex is determined, which represents whether the future behavior of the vertex will be impacted by the leader of the community that the vertex is a member of.

14. The system of claim 13, wherein a mathematical function is determined which best describes the mathematical relationship between the properties of network graph vertices, other available data and the target variable behavior.
